(19) United States
(12) Patent Application Publication
(10) Pub. No.: US 2026/0055749 A1
(43) Pub. Date: Feb. 26, 2026

(54) PULSE CAPTURE ASSEMBLY AND AN ENGINE SYSTEM

(71) Applicant: CUMMINS INC., Columbus, IN (US)

(72) Inventor: Scott Robert Bardakjy, Columbus, IN (US)

(73) Assignee: CUMMINS INC., Columbus, IN (US)

(21) Appl. No.: 19/257,161

(22) Filed: Jul. 1, 2025

Related U.S. Application Data
(60) Provisional application No. 63/686,345, filed on Aug. 23, 2024.

(51) Int. Cl. F02M 26/17

(52) U.S. Cl. CPC F02M 26/17

(57) ABSTRACT

A pulse capture assembly includes a flow combiner conduit. The flow combiner conduit is formed of a single piece of continuous material. The flow combiner conduit includes a middle portion, an inlet portion, and an outlet portion. The inlet portion has a first port in fluid providing communication with the middle portion and a second port in fluid providing communication with the middle portion. The second port is fluidly separated from the first port. The elbow portion has a third port in fluid receiving communication with the middle portion.

### CROSS-REFERENCE TO RELATED APPLICATIONS

This application claims priority to and the benefit of U.S. Patent Application No. 63/686,345, filed Aug. 23, 2024, the content of which is incorporated by reference in its entirety.

### TECHNICAL FIELD

The present disclosure generally relates to the field of exhaust gas recirculation systems.

### BACKGROUND

In an internal combustion engine system, an exhaust gas recirculation routes exhaust gas from an exhaust manifold to an intake manifold. The recirculated exhaust gas displaces air in the combustion chamber of the internal combustion engine, thereby reducing the amount of oxygen in the combustion chamber. The CO₂ in the recirculated exhaust gas has a higher specific heat capacity than air, thereby reducing the temperature of the combustion chamber and reducing the formation of NOx in the combustion chamber.

### SUMMARY OF THE INVENTION

Various embodiments provide for a pulse capture assembly. The pulse capture assembly includes a flow combiner conduit formed of a single piece of continuous material. The flow combiner conduit includes a middle portion. The flow combiner conduit includes an inlet portion having a first port in fluid providing communication with the middle portion and a second port in fluid providing communication with the middle portion. The second port is fluidly separated from the first port. The flow combiner conduit includes an elbow portion having a third port in fluid receiving communication with the middle portion.

Various other embodiments provide for an engine system. The engine system includes an intake manifold. The engine system includes an engine in fluid receiving communication with the intake manifold. The engine system includes an exhaust manifold in fluid receiving communication with the engine. The engine system includes a pulse capture assembly positioned below a top surface of the engine. The pulse capture assembly includes a flow combiner conduit. The flow combiner conduit includes a middle portion. The flow combiner conduit includes an inlet portion having (i) a first port in fluid providing communication with the middle portion and fluid providing communication with the exhaust manifold and (ii) a second port in fluid providing communication with the middle portion and fluid providing communication with the exhaust manifold. The flow combiner conduit includes an elbow portion in fluid receiving communication with the middle portion and fluid receiving communication with the intake manifold.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a schematic block diagram of an exhaust gas recirculation system, according to an example embodiment.

FIG. 2 is a schematic block diagram of an exhaust manifold usable in the engine system of FIG. 1.

FIG. 3 is a top view of an exhaust gas recirculation system, according to an example embodiment.

FIG. 4 is a side view of the exhaust gas recirculation system of FIG. 3.

FIG. 5 is a top view of a pulse capture assembly usable in the exhaust gas recirculation system of FIG. 1, shown in a disassembled state.

FIG. 6 is a front view of a flow combiner conduit usable in the pulse capture assembly of FIG. 5.

FIG. 7 is a side view of the flow combiner conduit of FIG. 6.

FIG. 8 is a cross-sectional view of the flow combiner conduit of FIG. 6.

FIG. 9 is another cross-sectional view of the flow combiner conduit of FIG. 6.

FIG. 10 is yet another cross-sectional view of the flow combiner conduit of FIG. 6.

### DETAILED DESCRIPTION

Embodiments described herein generally relate to an exhaust gas recirculation (EGR) system and/or components thereof. More specifically, the embodiments described herein relate to an exhaust gas recirculation system including an exhaust pulse capture assembly.

The exhaust pulse capture assembly, according to various embodiments, enables the EGR system to mitigate pressure change (e.g., a decrease in pressure) across the EGR system. In some embodiments, the components of the EGR system cooperate to improve (e.g., decrease) a brake-specific fuel consumption (BSFC) and brake thermal efficiency (BTE).

In some embodiments, the EGR system is structured to route exhaust gas from an exhaust manifold of an engine to an intake manifold of an engine. In some embodiments, the engine is an internal combustion engine that consumes fuel to produce mechanical power. In some embodiments, the engine is one of a diesel engine, a gasoline engine, a hydrogen engine, or a natural gas engine.

In an example embodiment, the EGR system is configured to recirculate exhaust gas for a natural gas engine. The EGR system includes a pulse capture assembly. The pulse capture assembly includes a flow combiner conduit formed of a single piece of continuous material. The flow combiner conduit includes a middle portion, an inlet portion having a first port in fluid providing communication with the middle portion and a second port in fluid providing communication with the middle portion, and an elbow position in fluid receiving communication with the middle portion.

Before turning to the figures, various embodiments of the exhaust gas recirculation system, the pulse capture assembly, and components thereof are described herein. It should be understood that, while individual components are described in detail, the details should be considered as examples only. Further, the details may include variations described herein. Accordingly, it should be understood that, although individual components may be described relative to an embodiment, any of the components may be used in any other embodiment described herein, unless otherwise noted.

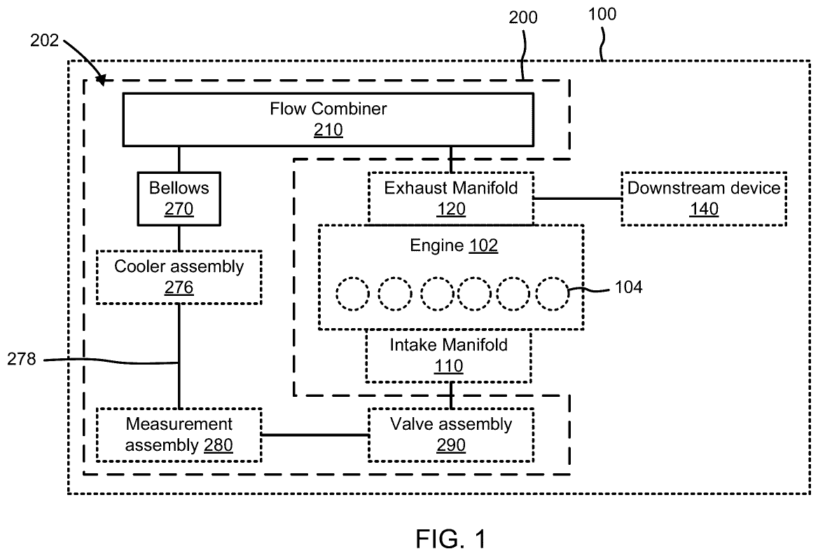

Referring to FIG. 1, a block diagram of an engine system 100 is shown, according to an example embodiment. The engine system 100 includes an engine 102. The engine system 100 also includes an intake manifold 110 and an exhaust manifold 120 fluidly coupled to the engine 102. The engine system includes an exhaust gas recirculation (EGR) system 200 fluidly coupled to the intake manifold 110 and the exhaust manifold 120. The EGR system 200 is configured to route at least a portion of an exhaust gas stream from the exhaust manifold 120 to the intake manifold 110.

In the configuration of FIG. 1, the engine system 100 is included in a vehicle. The vehicle can be any type of on-road or off-road vehicle including, but not limited to, wheel-loaders, fork-lift trucks, line-haul trucks, mid-range trucks (e.g., pick-up truck, etc.), sedans, coupes, tanks, airplanes, boats, and any other type of vehicle. In other embodiments, the engine system 100 can be embodied in a stationary piece of equipment, such as a power generator or genset. All such variations are intended to fall within the scope of the present disclosure.

In the configuration shown in FIG. 1, the engine 102 is an internal combustion engine (ICE). The ICE combusts fuel, such as diesel, gasoline, hydrogen, natural gas, etc., to generate power. In some embodiments, the engine 102 can be part of a hybrid engine system having a combination of an internal combustion engine and at least one electric machine coupled to at least one battery. In some embodiments, the engine system 100 can be configured as a mild-hybrid powertrain, a parallel hybrid powertrain, a series hybrid powertrain, or a series-parallel powertrain.

The engine 102 includes one or more cylinders 104 (e.g., combustion cylinders). The cylinders 104 are positioned within a combustion chamber of the engine 102. As shown in FIG. 1, the engine 102 includes six cylinders 104. However, it should be understood that the engine 102 can include more or fewer cylinder 104 (e.g., at least one) than as shown in FIG. 1. Furthermore, the cylinders 104 can be provided in any suitable arrangement (e.g., in-line, horizontal, V, or other suitable cylinder arrangement).

The engine system 100 includes an intake manifold 110. The intake manifold 110 is configured to route an intake gas stream, including air (e.g., ambient air, compressed air, etc.), to the engine 102. In some embodiments, the intake gas stream includes fuel. In some embodiments, the intake gas stream includes recirculated exhaust gas. Thus, the intake gas stream can include air and one or both of fuel and recirculated exhaust gas.

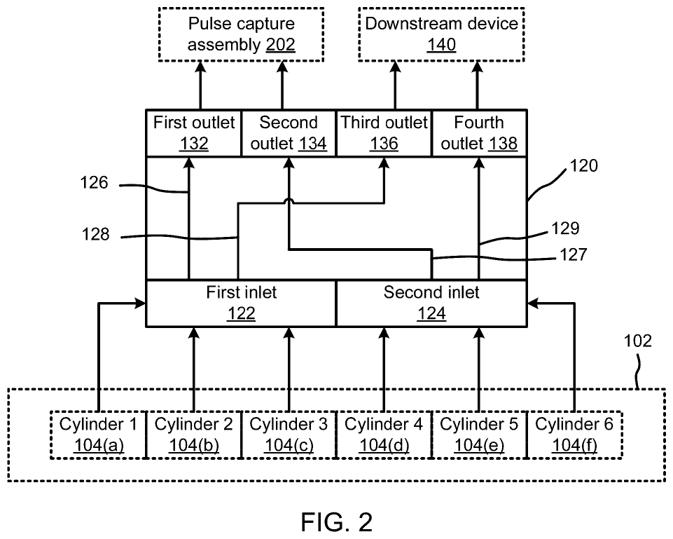

The engine system 100 includes an exhaust manifold 120. The exhaust manifold 120 is configured to route an exhaust gas stream from the engine 102 to one or more downstream components. For example, the exhaust manifold 120 is configured to route an exhaust gas stream from the engine 102 to at least the EGR system 200. The exhaust manifold 120 is described in greater detail herein with respect to FIG. 2.

In an example arrangement, the engine 102 receives an intake gas stream from the intake manifold 110. The intake gas stream can include air (e.g., ambient air), fuel, and/or recirculated exhaust gas (e.g., from the EGR system 200). As described above, the engine 102 combusts an air/fuel mixture and/or an air/fuel/exhaust gas mixture and outputs exhaust. The exhaust manifold 120 receives an exhaust gas stream from the engine 102.

As shown in FIG. 1, the EGR system 200 includes a pulse capture assembly 202. The pulse capture assembly 202 is configured to receive at least a portion of the exhaust gas stream (e.g., from the exhaust manifold 120). The EGR system 200 includes a cooler assembly 276. The EGR system 200 includes a measurement assembly 280. The EGR system 200 includes a conduit 278 that fluidly couples the cooler assembly 276 to the measurement assembly 280. The EGR system 200 includes a valve assembly 290. The EGR system 200 and components thereof are described in greater detail herein.

The EGR system 200 is shown with the other components of the engine system 100 (e.g., the engine 102 and components thereof, the intake manifold 110, the exhaust manifold 120, and a downstream device 140). It should be understood that the components of the engine system 100 shown in dashed lines are shown as an example only. Thus, some embodiments described herein relate to the EGR system 200, alone. Other embodiments described herein include the EGR system 200 and one or more other components of the engine system 100, such as the engine 102, the intake manifold 110 and/or the exhaust manifold 120. In these embodiments, for example, the pulse capture assembly 202 is in fluid receiving communication with the exhaust manifold 120 and fluid providing communication with the intake manifold 110.

As shown in FIG. 1, some components of the EGR system 200 (shown in dashed lines) are optional. For example, the measurement assembly 280, the cooler assembly 276 and/or the valve assembly 290 are optional. That is, in some embodiments, the EGR system 200 includes one or more of the measurement assembly 280, the cooler assembly 276, and/or the valve assembly 290. In other embodiments, the EGR system does not include the measurement assembly 280, the cooler assembly 276 and the valve assembly 290.

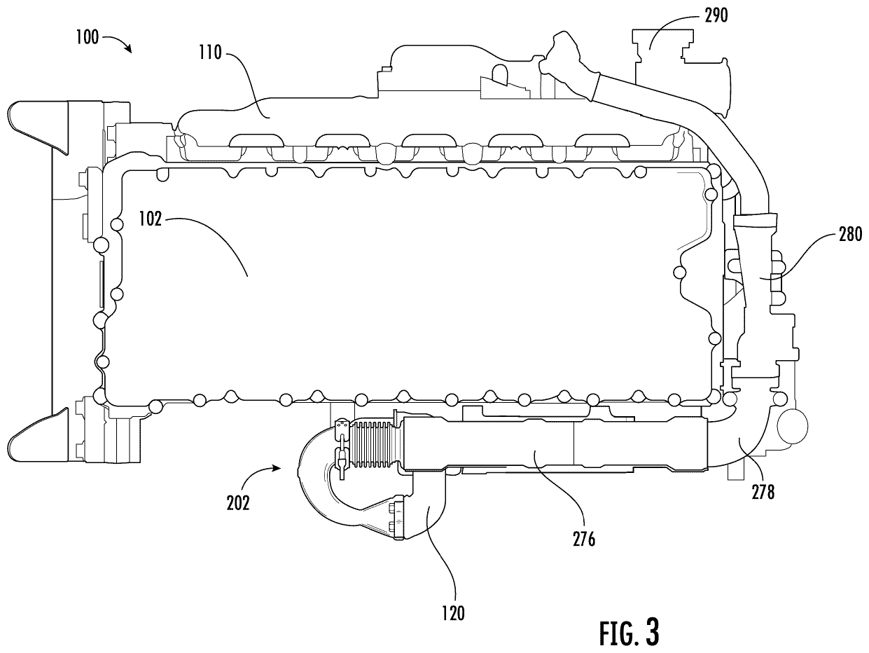

As shown in FIG. 3, the EGR system 200 (e.g., the pulse capture assembly 202, the cooler assembly 276, the conduit 278, the measurement assembly 280, the valve assembly 290, etc.) is not positioned above the engine 102. For example, the pulse capture assembly 202, the cooler assembly 276, the conduit 278, the measurement assembly 280, and the valve assembly 290 are positioned outside of a first volume extending upwards from the engine 102. As a result, a top of the engine 102 may be accessed without removing a component of the EGR system 200. In some embodiments, the EGR system 200 is positioned outside of a second volume extending downwards form the engine 102. As shown in FIG. 3, the EGR system 200 extends forward of the engine 102 when the EGR system 200 extends between the exhaust manifold 120 and the intake manifold 110. For example, the EGR system 200 extends around a front of the engine 102 when extending between the exhaust manifold 120 and the intake manifold 110.

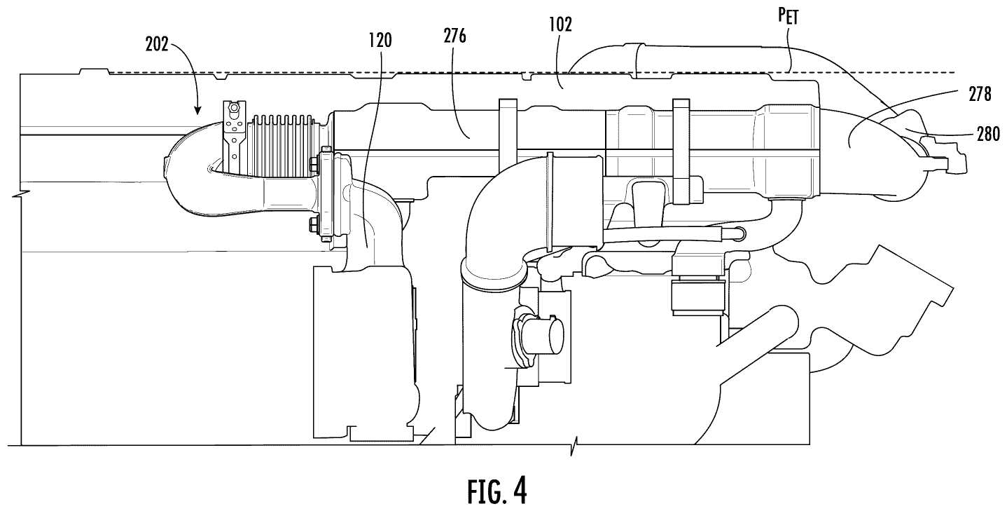

As shown in FIG. 4, at least a portion of the EGR system 200 is positioned below a plane PET extending along a top surface of the engine 102 (e.g., an uppermost surface, a horizontal top surface extending along an uppermost point of the engine 102, etc.). For example, the pulse capture assembly 202, the cooler assembly 276, the conduit 278, and the measurement assembly 280 may be positioned below the plane PET. In some embodiments, the valve assembly 290 is positioned below the plane PET.

The pulse capture assembly 202 includes a flow combiner conduit 210 formed of a single piece of continuous material. The flow combiner conduit 210 includes a middle portion 216, an inlet portion 214, and an elbow portion 218. The inlet portion 214 includes a first port 220 in fluid providing communication with the middle portion 216. The second port 222 is fluidly separated from the first port 220. The elbow portion 218 has a third port 252 is in fluid receiving communication with the middle portion 216.

As noted above, the flow combiner conduit 210 is formed of a single piece of continuous material. For example, the flow combiner conduit 210 may be formed of a piece of monolithic material, a single piece of material, a unibody component, a unitary constructed component, integrally formed, a one-piece component, formed from a homogeneous material, a unified component, etc.

In some embodiments, the first port 220 and the second port 222 are oriented toward a forward end of the engine 102 (e.g., the first port 220 and the second port 222 open toward the forward end of the engine 102, etc.).

The engine system 100 includes the intake manifold 110, the engine 102 in fluid receiving communication with the intake manifold 110, the exhaust manifold 120 in fluid receiving communication with the engine 102, and the pulse capture assembly 202 positioned below the top surface of the engine 102. The pulse capture assembly 202 includes the flow combiner conduit 210. The flow combiner conduit 210 includes the middle portion 216, the inlet portion 214, and the elbow portion 218. The inlet portion 214 includes (i) the first port 220 in fluid providing communication with the middle portion 216 and fluid providing communication with the exhaust manifold 120 and (ii) the second port 222 in fluid providing communication with the middle portion 216 and fluid providing communication with the exhaust manifold 120. The elbow portion 218 is in fluid receiving communication with the middle portion 216 and fluid receiving communication with the intake manifold 110.

In some embodiments, the engine system 100 includes the engine 102, the intake manifold 110, the exhaust manifold 120, the downstream device 140, and the EGR system 200. The downstream device 140 may be any suitable component positioned downstream of the exhaust manifold 120. In some embodiments, the downstream device 140 is coupled to the exhaust manifold 120 such that the downstream device 140 receives at least a portion of an exhaust gas stream from the exhaust manifold 120.

In some embodiments, downstream device 140 is a turbo device. The turbo device can be any type of turbo machinery, such as a turbocharger, a variable geometry turbocharger, a power turbine, etc. In some embodiments, the turbo device is operatively coupled to the engine 102 and/or another component of the engine system 100, such as a drivetrain, a battery, an electric machine, or other suitable component.

In some embodiments, the downstream device 140 is a dual-wastage turbocharger. The dual-wastage turbocharger includes a first inlet and a second inlet. The first inlet is configured to receive a first portion of an exhaust gas stream (e.g., from the exhaust manifold 120). The second inlet is configured to receive a second portion of an exhaust gas stream (e.g., from the exhaust manifold 120).

As described above, in some embodiments, one or more of the engine 102, the intake manifold 110, the exhaust manifold 120, and the downstream device 140 may not be included in a provided system, i.e., a system or subsystem may be provided comprising less than all of the components of the engine system 100.

The flow path of a gas stream (e.g., an exhaust gas stream, or a portion thereof) flowing through the EGR system 200 is shown in FIG. 1. Further, the relative positioning of the components of the EGR system 200 is shown in FIG. 1. However, it should be understood that the relative positioning of the components of the EGR system 200 is shown as an example only, and in other embodiments, the components of the EGR system 200 may be positioned in a different order and/or the EGR system 200 may include more, or fewer components than as shown in FIG. 1. The positioning of the components of the EGR system 200 are described herein with respect to FIG. 1.

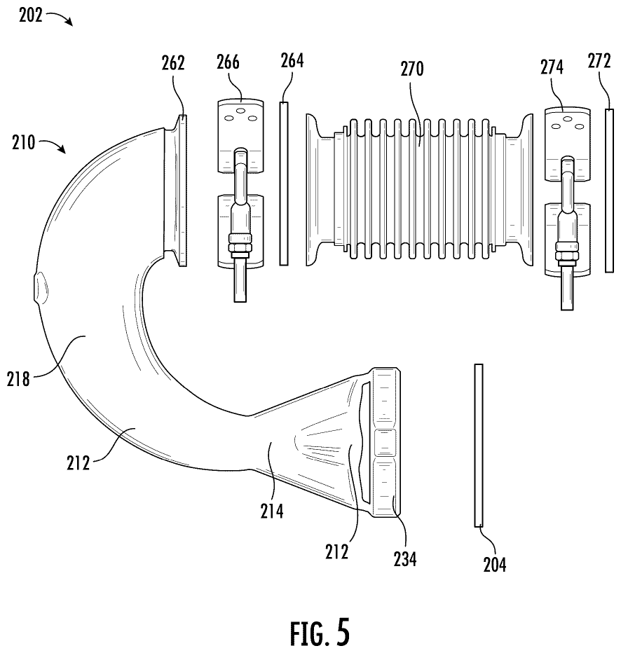

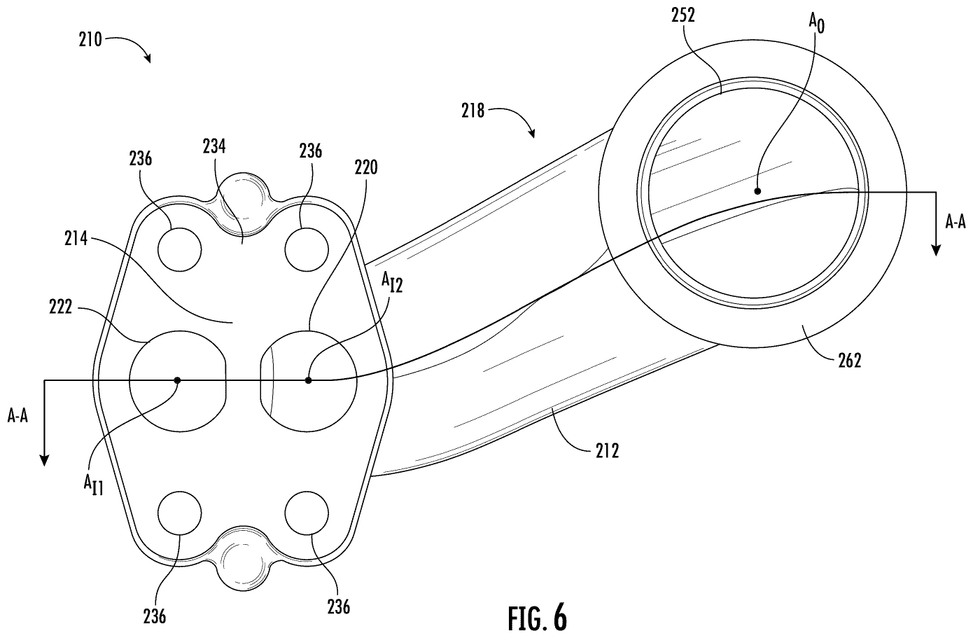

As shown in FIG. 1, the EGR system 200 includes the pulse capture assembly 202. The pulse capture assembly 202 includes the flow combiner conduit 210 and a bellows 270. The structure and function of each component of the pulse capture assembly 202 is described herein with respect to FIGS. 5-10.

The flow combiner conduit 210 is coupled on the exhaust manifold 120. A first end of the flow combiner conduit 210 is coupled to the exhaust manifold 120. The flow combiner conduit 210 is in fluid receiving communication with the exhaust manifold 120. The exhaust manifold 120 is in fluid providing communication with the flow combiner conduit 210. A second end of the flow combiner conduit 210 is coupled to the bellows 270.

The bellows 270 is positioned downstream of the flow combiner conduit 210. The bellows 270 is coupled to the flow combiner conduit 210 (e.g., the second end of the flow combiner conduit 210). The bellows 270 is in fluid receiving communication with the flow combiner conduit 210. The flow combiner conduit 210 is in fluid providing communication with the bellows 270. A second end of the bellows 270 is coupled to the cooler assembly 276. In other embodiments, the pulse capture assembly 202 does not include the bellows 270.

In some embodiments, the EGR system 200 includes the cooler assembly 276. The cooler assembly 276 is coupled to the bellows 270. A first end of the cooler assembly 276 is coupled to the bellows 270 (e.g., the second end of the bellows 270). The cooler assembly 276 is in fluid receiving communication with the bellows 270. The bellows 270 is in fluid providing communication with the cooler assembly 276. A second end of the cooler assembly 276 is coupled to the conduit 278. In other embodiments, the EGR system 200 does not include the cooler assembly 276. In these embodiments, the bellows 270 is fluidly coupled to the measurement assembly 280 or the valve assembly 290. In other embodiments, the pulse capture assembly 202 does not include the bellows 270. In these embodiments, the cooler assembly 276 is fluidly coupled to the cooler assembly 276.

The cooler assembly 276 is configured to facilitate thermal cooling of an exhaust gas stream flowing therethrough. For example, the cooler assembly 276 can include a heat exchanger configured to reduce the temperature of the exhaust gas stream flowing through the cooler assembly 276.

The conduit 278 is coupled to the cooler assembly 276. A first end of the conduit 278 is coupled to the cooler assembly 276 (e.g., the second end of the cooler assembly 276). The conduit 278 is in fluid receiving communication with the cooler assembly 276. The cooler assembly 276 is in fluid providing communication with the conduit 278. A second end of the cooler assembly 276 is coupled to the measurement assembly 280. The conduit 278 is configured to route an exhaust gas stream from the cooler assembly 276 to the measurement assembly 280.

In some embodiments, the EGR system 200 includes the measurement assembly 280. The measurement assembly 280 is coupled to the conduit 278. A first end of the measurement assembly 280 is coupled to the conduit 278 (e.g., the second end of the conduit 278). The measurement assembly 280 is in fluid receiving communication with the conduit 278. The conduit 278 is in fluid providing communication with the measurement assembly 280. A second end of the cooler assembly 276 is coupled to the valve assembly 290. In other embodiments, the EGR system 200 does not include the measurement assembly 280.

In some embodiments, the EGR system 200 includes the valve assembly 290. The valve assembly 290 is coupled to the measurement assembly 280. A first end of the valve assembly 290 is coupled to the measurement assembly 280 (e.g., the second end of the measurement assembly 280). The valve assembly 290 is in fluid receiving communication with the measurement assembly 280. The measurement assembly 280 is in fluid providing communication with the valve assembly 290. A second end of the valve assembly 290 is coupled to the intake manifold 110. The valve assembly 290 is in fluid providing communication with the intake manifold 110. The intake manifold 110 is in fluid receiving communication with the valve assembly 290. In other embodiments, the EGR system 200 does not include the valve assembly 290. In these embodiments, the measurement assembly 280 is fluidly coupled to the engine 102 (e.g., via the intake manifold 110).

The valve assembly 290 is configured to selectively provide the exhaust gas stream to the intake manifold 110. In some embodiments, the valve assembly 290 includes a valve that is operable between an open position and a closed position. In the open position the valve allows a maximum amount of flow rate therethrough. In the closed position the valve allows a minimum amount of flow rate therethrough (e.g., no flow). In an intermediate position, the valve allows an intermediate flow rate therethrough.

Now referring to FIG. 2, a schematic block diagram of a portion of the engine system 100 is shown, according to an example embodiment. In particular, the exhaust manifold 120 is shown, according to an example embodiment.

As described above, the engine 102 includes one or more cylinders 104. As shown in FIG. 2, the engine 102 includes six cylinders 104 (e.g., a first cylinder 104 (a), a second cylinder 104 (b), a third cylinder 104 (c), a fourth cylinder 104 (d), a fifth cylinder 104 (e), and a sixth cylinder 104 (f)). It should be understood that the engine 102 can include more or fewer cylinder 104 (e.g., at least one) than as shown in FIG. 2. The cylinders 104 can be provided in any suitable arrangement (e.g., in-line, horizontal, V, or other suitable cylinder arrangement).

The exhaust manifold 120 is fluidly coupled to the engine 102. The exhaust manifold 120 receives an exhaust gas stream from the engine 102. In some embodiments, the exhaust manifold 120 includes a first inlet portion 122 and a second inlet portion 124. The first inlet portion 122 is configured to receive an exhaust gas stream from a first set of cylinders 104 (e.g., the first cylinder 104 (a), the second cylinder 104 (b), and the third cylinder 104 (c)). The first inlet portion 122 includes one or more inlet ports (e.g., openings, etc.) that each enable fluid communication between a corresponding cylinder and the exhaust manifold 120. The second inlet portion 124 is configured to receive an exhaust gas stream from a second set of cylinders 104 (e.g., the fourth cylinder 104 (d), the fifth cylinder 104 (c), and the sixth cylinder 104 (f)). The second inlet portion 124 includes one or more inlet ports (e.g., openings, etc.) that each enable fluid communication between a corresponding cylinder and the exhaust manifold 120.

The exhaust manifold 120 includes a first outlet portion 132, a second outlet portion 134, a third outlet portion 136, and a fourth outlet portion 138. The first outlet portion 132 is configured to route a first portion of the exhaust gas to the pulse capture assembly 202. The first outlet portion 132 is fluidly coupled to the pulse capture assembly 202. The second outlet portion 134 is configured to route a second portion of the exhaust gas to the pulse capture assembly 202. The second outlet portion 134 is fluidly coupled to the pulse capture assembly 202. The third outlet portion 136 is configured to route a third portion of the exhaust gas to the downstream device 140. The third outlet portion 136 is fluidly coupled to the downstream device 140. The fourth outlet portion 138 is configured to route a fourth portion of the exhaust gas to the downstream device 140. The fourth outlet portion 138 is fluidly coupled to the downstream device 140.

The exhaust manifold 120 includes one or more flow channels (e.g., conduits, channels, etc.) for routing the received exhaust gas (e.g., the exhaust gas received at the first inlet portion 122 and/or the second inlet portion 124) to a downstream component (e.g., the pulse capture assembly 202 and/or the downstream device 140). A first flow channel 126 of the one or more flow channels is configured to route a first portion of an exhaust gas stream from the first inlet portion 122 to the first outlet portion 132. A second flow channel 127 of the one or more flow channels is configured to route a second portion of an exhaust gas stream from the second inlet portion 124 to the second outlet portion 134. A third flow channel 128 of the one or more flow channels is configured to route a third portion of an exhaust gas stream from the first inlet portion 122 to the third outlet portion 136. A fourth flow channel 129 of the one or more flow channels is configured to route a fourth portion of an exhaust gas stream from the second inlet portion 124 to the fourth outlet portion 138.

The exhaust manifold 120 routes the first portion of the exhaust gas stream from the first set of cylinders (e.g., the first cylinder 104 (a), the second cylinder 104 (b), and the third cylinder 104 (c)) to the pulse capture assembly 202. The exhaust manifold 120 routes the second portion of the exhaust gas stream from the second set of cylinders (e.g., the fourth cylinder 104 (d), the fifth cylinder 104 (c), and the sixth cylinder 104 (f)) to the pulse capture assembly 202.

In an example embodiment, the flow combiner conduit 210 is in fluid receiving communication with the exhaust manifold 120. The exhaust manifold 120 includes the first outlet portion 132 and the second outlet portion 134. The first port 220 of the flow combiner conduit is in exhaust gas receiving communication with the first outlet portion 132. The second port 222 of the flow combiner conduit 210 is in exhaust gas receiving communication with the second outlet portion 134. For example, the flow combiner conduit 210 is configured to receive a first exhaust gas stream portion at the first port 220 via the first outlet portion 132 and a second exhaust gas stream portion at the second port 222 via the second outlet portion 134.

The exhaust manifold 120 includes the first inlet portion 122, the second inlet portion 124, and one or more flow channels. The first inlet portion 122 is in exhaust gas receiving communication with the first set of cylinders 104 of the engine 102. The second inlet portion 124 is in exhaust gas receiving communication with the second set of cylinders 104 of the engine 102. For example, the first inlet portion 122 is configured to receive a first exhaust gas stream from the first set of cylinders 104 of the engine 102, and the second inlet portion 124 is configured to receive a second exhaust gas stream from the second set of cylinders 104 of the engine 102. The first flow channel 126 of the one or more flow channels is configured to route the first exhaust gas stream portion (e.g., a portion of the first exhaust gas stream) from the first inlet portion 122 to the first outlet portion 132. The second flow channel 127 of the one or more flow channels is configured to route the second exhaust gas stream portion (e.g., a portion of the second exhaust gas stream) from the second inlet portion 124 to the second outlet portion 134.

Now referring to FIG. 5, a top view of the pulse capture assembly 202 is shown. The pulse capture assembly 202 is shown in a disassembled state. In an example embodiment, the pulse capture assembly 202 for the exhaust gas recirculation system 200 includes the flow combiner conduit 210 and the bellows 270.

The flow combiner conduit 210 includes a middle portion 216, an inlet portion 214, and an elbow portion 218 that are formed from the single piece of continuous material. The inlet portion 214 includes the first port 220 in fluid providing communication with the middle portion 216 and the second port 222 in fluid providing communication with the middle portion 216. The second port 222 is fluidly separated from the first port 220. The elbow portion 218 includes the third port 252 in fluid receiving communication with the middle portion 216. In some embodiments, the third port 252 is oriented toward the forward end of the engine 102 (e.g., an opening of the third port 252 is directed toward the forward end of the engine 102, the opening of the third port 252 is directed in a same direction as the openings of the first port 220 and the second port 222, etc.).

In some embodiments, the third port 252 is positioned rearward of the first port 220 and the second port 222. For example, the first port 220 and the second port 222 are positioned at a forward end of the conduit body 212, a rearmost portion of the elbow portion 218 is positioned at a rearward end of the conduit body 212, and the third port 252 is positioned between the forward end of the conduit body 212 and the rearward end of the conduit body 212.

By forming the flow combiner conduit 210 from the single piece of continuous material, the pulse capture assembly 202 may be formed without potential leak paths between the middle portion 216 and the inlet portion 214 and between the middle portion 216 and the elbow portion 218. Advantageously, the reduction or mitigation in leak paths in the pulse capture assembly 202 reduces a change that exhaust leaks out of the pulse capture assembly 202 and into the surrounding environment. For example, when the flow combiner conduit 210 is formed from the single piece of continuous material, exhaust may not leak from the flow combiner conduit 210 at locations in between the middle portion 216 and the inlet portion 214 or from in between the middle portion 216 and the elbow portion 218.

When included, the bellows 270 is positioned downstream of the flow combiner conduit 210 and is in fluid receiving communication with the third port 252.

In some embodiments, the pulse capture assembly 202 includes a first sealing member 204. The first sealing member 204 is located between the exhaust manifold 120 and the pulse capture assembly 202. The first sealing member 204 is configured to form a seal between the exhaust manifold 120 and the pulse capture assembly 202.

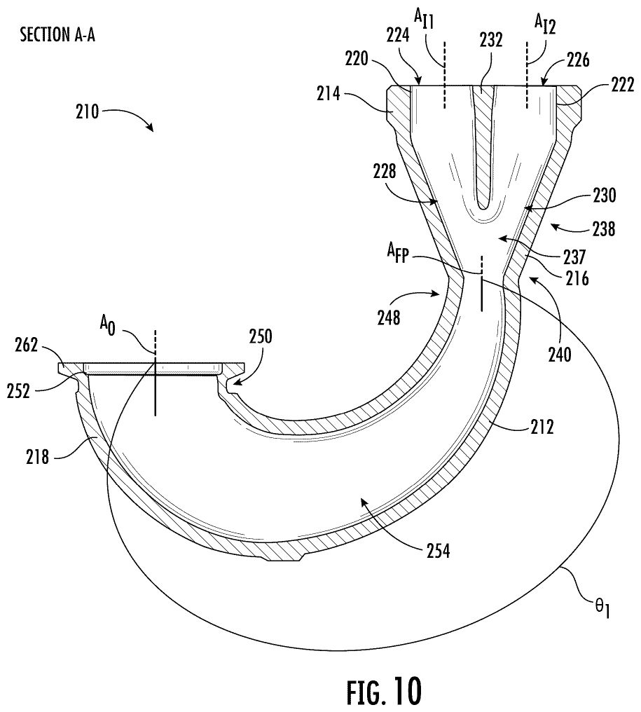

The pulse capture assembly 202 includes the flow combiner conduit 210. A section view of the flow combiner conduit 210 is shown in FIG. 10. The flow combiner conduit 210 is a conduit that is configured to receive two gas streams (e.g., a first exhaust gas stream portion and a second exhaust gas stream portion). The flow combiner conduit 210 receives the two gas streams from an upstream component, such as the exhaust manifold 120. The flow combiner conduit 210 is configured to combine the two gas streams into a single (e.g., combine) gas stream.

The flow combiner conduit 210 is configured to provide the combine gas stream to a downstream component (e.g., the bellows 270, or another downstream component). In an example embodiment, a geometry of the flow combiner conduit 210 enables mixing of the first exhaust gas stream portion and the second exhaust gas stream portion while mitigating turbulence in the combine gas stream. For example, the geometry of the flow combiner conduit 210 enables mixing of the first exhaust gas stream portion and the second exhaust gas stream portion such that the flow through the flow combiner conduit 210 is a substantially laminar flow.

The flow combiner conduit 210 includes a conduit body 212. The conduit body 212 includes the inlet portion 214, the middle portion 216, and the elbow portion 218. The inlet portion 214 is located at a first end of the conduit body 212. The elbow portion 218 is located at a second end of the conduit body 212, opposite the first end. The middle portion 216 is positioned between the inlet portion 214 and the elbow portion 218 (e.g., between the first end and the second end of the conduit body 212).

The inlet portion 214 includes the first port 220 (e.g., a first inlet port) and the second port 222 (e.g., a second inlet port). The first port 220 is defined by a first inlet axis A₁₁ and the second port 222 is defined by a second inlet A₁₁. The first inlet axis A₁₁ and the second inlet A₁₂ are oriented parallel with each other. In some embodiments, the first inlet axis A₁₁ and the second inlet A₁₁ are coplanar on a horizontal plane extending through the flow combiner conduit 210. In other embodiments, the first inlet axis A₁₁ and the second inlet A₁₁ are coplanar on a non-horizontal plane (e.g., a vertical plane, an angled plane, etc.) extending through the flow combiner conduit 210.

A first end 224 of the first port 220 and a first end 226 of the second port 222 proximate the first end of the conduit body 212 have a first cross-sectional area (e.g., a flow-by area, etc.). A second end 228 of the first port 220 and a second end 230 of the second port 222 proximate the inlet portion 214 have a second cross-sectional area, smaller than the first cross-sectional area. In an example embodiment, a first ratio of the first cross-sectional area of the first port 220 and the second port 222 to the second cross-sectional area of the first port 220 and the second port 222 is between about 1.25 and about 1.75, for example about 1.53.

At the inlet portion 214 of the conduit body 212, the first port 220 is separated from the second port 222 by a conduit wall 232. The conduit wall 232 extends from the first end of the conduit body 212 towards the middle portion 216. In some embodiments, the conduit wall 232 extends to or into the middle portion 216. In other embodiments, the conduit wall 232 does not extend into the middle portion 216.

The first port 220 is configured to receive a first portion of an exhaust gas stream. In some embodiments, the first port 220 is fluidly coupled to the first outlet portion 132 of the exhaust manifold 120 such that the first port 220 receives the first portion of the exhaust gas stream from the exhaust manifold 120 via the first outlet portion 132. The flow combiner conduit 210 is configured to receive a first exhaust gas stream portion at the first port 220 via the first outlet portion 132.

The second port 222 is configured to receive a second portion of an exhaust gas stream. In some embodiments, the second port 222 is fluidly coupled to the second outlet portion 134 of the exhaust manifold 120 such that the second port 222 receives the second portion of the exhaust gas stream from the exhaust manifold 120 via the second outlet portion 134. The flow combiner conduit 210 is configured to receive a second exhaust gas stream portion at the second port 222 via the second outlet portion 134.

The two-inlet design of the flow combiner conduit 210 advantageously enables the flow combiner conduit 210 to receive two different exhaust gas streams from the exhaust manifold 120 (e.g., a “split manifold”). As described above with respect to FIG. 2, the first exhaust gas stream portion is received from the first set of cylinders 104, and the second exhaust gas stream portion is received from the second set of cylinders 104.

In some embodiments, the exhaust gas flow has an “alternate pulsation.” As used herein, an “alternate pulsation” refers to alternating flows in exhaust gas streams caused by the timing of opening and/or closing of exhaust valves of the cylinders 104. For example, the flow combiner conduit 210 receives a first “pulse” of the first exhaust gas stream portion (e.g., via the first port 220) before receiving a second “pulse” of the second exhaust gas stream portion (e.g., via the second port 222). The flow combiner conduit 210 advantageously facilitates combining the first exhaust gas stream portion and the second exhaust gas stream portion therein, and, due to the alternate pulsation in the first exhaust gas stream portion and the second exhaust gas stream portion, the flow combiner conduit 210 substantially prevents backwards flow. For example, the flow combiner conduit 210 substantially prevents the first exhaust gas stream portion from flowing through the second port 222. The flow combiner conduit 210 substantially prevents the second exhaust gas stream portion from flowing through the first port 220.

The inlet portion 214 includes a first mounting flange 234 that extends outward (e.g., radially outward, etc.) from the inlet portion 214 at the first end of the conduit body 212. In some embodiments, the first mounting flange 234 is monolithically formed with the inlet portion 214 (e.g., monolithically formed with the conduit body 212, the conduit body 212 and the first mounting flange 234 are formed form a single continuous material, etc.). The first mounting flange 234 defines one or more openings 236. The one or more openings 236 are each sized to receive a fastener. When each of the one or more openings 236 receives a fastener, the fasteners couple the flow combiner conduit 210 to the exhaust manifold 120. In this way, the first mounting flange 234 enables coupling the flow combiner conduit 210 to the exhaust manifold 120. In other embodiments, the first mounting flange 234 enables coupling the flow combiner conduit 210 to the engine 102. For example, when each of the one or more openings 236 receive a fastener, the fasteners couple the flow combiner conduit 210 to the engine 102.

In some embodiments, the first mounting flange 234 includes a first portion extending upward from the inlet portion 214 and a second portion extending downward from the inlet portion 214. Each of the first portion of the first mounting flange 234 and the second portion of the first mounting flange 234 define at least one of the one or more openings 236. In this way, the first mounting flange 234 enables coupling the flow combiner conduit 210 to the exhaust manifold 120 at a first location above the inlet portion 214 (e.g., above the first port 220 and the second port 222, etc.) and coupling the flow combiner conduit 210 to the exhaust manifold 120 at a second location below the inlet portion 214 (e.g., below the first port 220 and the second port 222, etc.). In other embodiments, the first mounting flange 234 includes portions extending outward from a side (e.g., a left side, a right side, etc.) of the inlet portion 214.

The middle portion 216 of the conduit body 212 is configured to receive the first gas stream portion and the second gas stream portion. The middle portion 216 defines a middle opening 237 extending from a first end 238 of the middle portion 216 proximate the inlet portion 214 to a second end 240 of the middle portion 216 opposite the first end 238. The middle portion 216 is configured to enable mixing of the first gas stream portion and the second gas stream portion. In an example embodiment, the first gas stream flowing from the first port 220 and the second gas stream flowing form the second port 222 enter the middle portion 216 of the conduit body 212 and are allowed to mix therein. The combine gas stream then flows into the elbow portion 218.

The middle opening 237 at the first end 238 of the middle portion 216 has a third cross-sectional area, larger than the second cross-sectional area of the first port 220 and the second port 222. In some embodiments, the third cross-sectional area of the middle opening 237 at the first end 238 of the middle portion 216 is larger than the first cross-sectional of the first port 220 and the second port 222. The middle opening 237 at the second end 240 of the middle portion 216 proximate the elbow portion 218 has a fourth cross-sectional area, smaller than the third cross-sectional area.

In some embodiments, the fourth cross sectional area of the middle opening 237 is smaller than the first cross-sectional area of the first port 220 and the second port 222. In an example embodiment, a second ratio of the first cross-sectional area of the first port 220 and the second port 222 to the fourth cross-sectional area of the middle opening 237 is between about 1.25 and about 1.75, for example about 1.48.

In some embodiments, the fourth cross-sectional area of the middle opening 237 is larger than the second cross-sectional area of the first port 220 and the second port 222. In an example embodiment, a third ratio of the second cross-sectional area of the first port 220 and the second port 222 to the fourth cross-sectional area of the middle opening 237 is between about 0.75 and about 1.25, for example about 0.97. In another example embodiment, a third ratio of the second cross-sectional area of the first port 220 and the second port 222 to the fourth cross-sectional area of the middle opening 237 is between about 0.75 and about 1.00, for example about 0.97.

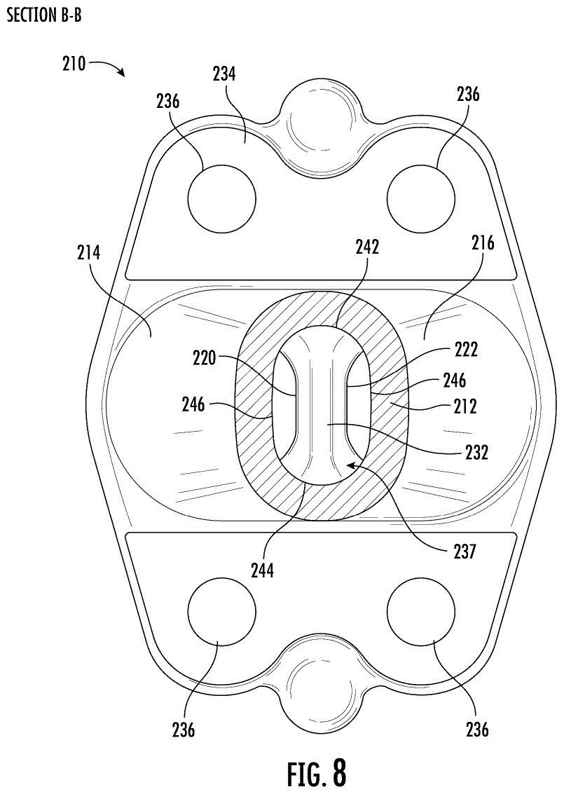

The middle opening 237 at the second end 240 of the middle portion 216 has a rounded cross-sectional shape. According to the example embodiment shown in FIG. 8, the middle opening 237 at the second end 240 of the middle portion 216 has a race-track cross-sectional shape. The race-track cross-sectional shape includes a first rounded cross-sectional profile 242, a second rounded cross-sectional profile 244, and a pair of straight cross-sectional profiles 246 extending between the first rounded cross-sectional profile 242 and the second rounded cross-sectional profile 244. In an example embodiment, a first of the straight cross-sectional profiles 246 extends between first sides of the first rounded cross-sectional profile 242 and the second rounded cross-sectional profile 244 and a second of the straight cross-sectional profiles 246 extends between second sides of the first rounded cross-sectional profile 242 and the second rounded cross-sectional profile 244, the second sides of the first rounded cross-sectional profile 242 and the second rounded cross-sectional profile 244 opposing the first sides of the first rounded cross-sectional profile 242 and the second rounded cross-sectional profile 244. In other embodiments, the middle opening 237 at the second end 240 of the middle portion 216 has an elliptical cross-sectional shape or a circular cross-sectional shape.

The elbow portion 218 is configured to receive the combine gas stream. The elbow portion 218 is configured to direct the combine gas stream to a downstream component, such as the cooler assembly 276, the measurement assembly 280, and/or another downstream component.

The elbow portion 218 includes the third port 252 (e.g., an outlet port). The third port 252 is configured to provide the combine gas stream to a downstream component, such as the bellows 270. The third port 252 is defined by an outlet axis A_{O}. In some embodiments, the outlet axis A_{O} is oriented parallel to the first inlet axis A₁₁ and the second inlet A₁₂. In other embodiments, the outlet axis A_{O} is oriented non-parallel (e.g., perpendicular, etc.) to the first inlet axis A₁₁ and the second inlet A₁₂. In some embodiments, the outlet axis A_{O} is positioned a distance above the first inlet axis A₁₁ and the second inlet A₁₂. By way of example, the elbow portion 218 may extend upward from a first end 248 of the elbow portion 218 proximate the middle portion 216 to a second end 250 of the elbow portion 218, opposite the first end 248 of the elbow portion 218. In other embodiments, the first inlet axis A₁₁, the second inlet A₁₁, and the outlet axis A_{O} are coplanar. In still other embodiments, the outlet axis A_{O} is positioned a distance below the first inlet axis A₁₁ and the second inlet A₁₂.

Referring to FIG. 10, the elbow portion 218 defines a fluid flow path 254 extending from the first end 248 of the elbow portion 218 to the second end 250 of the elbow portion 218. The fluid flow path 254 at the first end 248 of the elbow portion 218 is defined by a flow path axis A_{FP} and the fluid flow path 254 at the second end 250 of the elbow portion 218 is defined by the outlet axis A_{O}. In some embodiments, the flow path axis A_{FP} is oriented parallel to the first inlet axis A₁₁, the second inlet A₁₂, and/or the outlet axis A_{O}. In other embodiments, the flow path axis A_{FP} is oriented non-parallel (e.g., perpendicular, etc.) to the first inlet axis A₁₁, the second inlet A₁₂, and/or the outlet axis A_{O}.

The fluid flow path 254 at the first end 248 of the elbow portion 218 has a fifth cross-sectional area that is substantially similar to or the same as the fourth cross-sectional area of the middle opening 237. The fluid flow path 254 at the second end 250 of the elbow portion 218 has a sixth cross-sectional area, larger than the fourth cross-sectional area of the middle opening 237. In some embodiments, the sixth cross-sectional area of the fluid flow path 254 is larger than the first cross-sectional area and the second cross-sectional area of the first port 220 and the second port 222. In some embodiments, the sixth cross-sectional area of the fluid flow path 254 is larger than the third cross-sectional area of the middle opening 237 of the middle portion 216 and the fourth cross-sectional area of the middle opening 237 of the middle portion 216.

The geometry (e.g., a cross-sectional geometry, a flow-by area, a cross-sectional diameter) of the conduit body 212 enables the first gas stream and the second gas stream to mix while mitigating turbulence. Advantageously, the reduction or mitigation of turbulence in the combine gas stream reduces a pressure change (e.g., a decrease in pressure) as the gas stream flows through the flow combiner conduit 210. For example, the increasing cross-sectional area of the elbow portion 218 advantageously reduces the velocity of the combine gas stream. The relative size of the fifth cross-sectional area and the sixth cross-sectional area of the elbow portion 218 can be selected to improve (e.g., decrease) the change in pressure (e.g., decrease in pressure). For example, the geometry of the elbow portion 218 mitigates flow separation (e.g., turbulence) and/or reduce velocity to increase pressure.

The fluid flow path 254 changes in direction by a first angle θ₁ between the flow path axis A_{FP} at the first end 248 of the elbow portion 218 and the outlet axis A_{O} at the second end 250 of the elbow portion 218. According to an example embodiment, the fluid flow path 254 is substantially semi-circular in shape (e.g., semi-circular, semi-elliptical, semi-ovular, etc.), such that the first angle θ₁ of the change in direction of the fluid flow path 254 through the elbow portion 218 is approximately 180°, such as between 160° and 200°. The elbow portion 218 has a rounded cross-sectional shape.

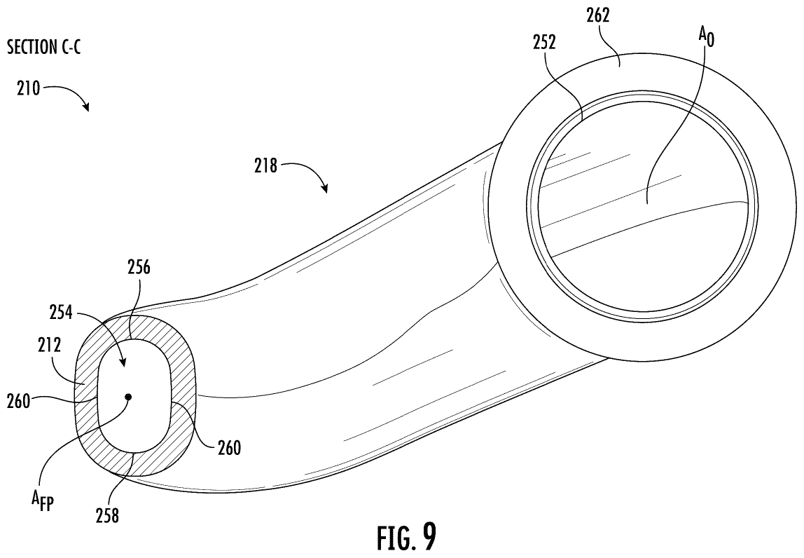

According to the example embodiment shown in FIG. 9, the fluid flow path 254 defined by the elbow portion 218 has a race-track cross-sectional shape at the first end 248 of the elbow portion 218 (e.g., proximate the middle portion 216, at an upstream end of the fluid flow path 254, etc.) to match the race-track cross-sectional shape of the middle opening 237 at the second end 240 of the middle portion 216, a substantially circular cross-sectional shape at the second end 250 of the elbow portion 218 (e.g., at a downstream end of the fluid flow path 254, etc.), and an intermediate cross-sectional shape extending between the race-track cross-sectional shape and the substantially circular cross-sectional shape configured such that the intermediate cross-sectional shape smoothly transitions from the race-track cross-sectional shape to the substantially circular cross-sectional shape. The race-track cross-sectional shape of the fluid flow path 254 includes a first rounded cross-sectional profile 256, a second rounded cross-sectional profile 258, and a pair of straight cross-sectional profiles 260 extending between the first rounded cross-sectional profile 242 and the second rounded cross-sectional profile 244. In various embodiments, the fluid flow path 254 has a race-track cross-sectional shape, an ovular cross-sectional shape, an elliptical cross-sectional shape, a circular cross-sectional shape, and/or intermediate cross-sectional shapes that transition between any of the other of the cross-sectional shapes.

A cross-sectional area of the fluid flow path 254 defined by the elbow portion 218 increases from the first end 248 of the elbow portion 218 (e.g., at the upstream end of the fluid flow path 254, the fifth cross-sectional area of the elbow portion 218) to the second end 250 of the elbow portion 218 (e.g., at the downstream end of the fluid flow path 254, the sixth cross-sectional area of the elbow portion 218). For example, the cross-sectional area of the fluid flow path 254 increases along a length of the fluid flow path 254 from the inlet portion 214 to the third port 252.

In some embodiments, the fluid flow path 254 extends upward from the first end 248 of the elbow portion 218 to the second end 250 of the elbow portion 218 such that the fluid flow path 254 at the first end 248 of the elbow portion 218 is lower than the fluid flow path 254 at the second end 250 of the elbow portion 218.

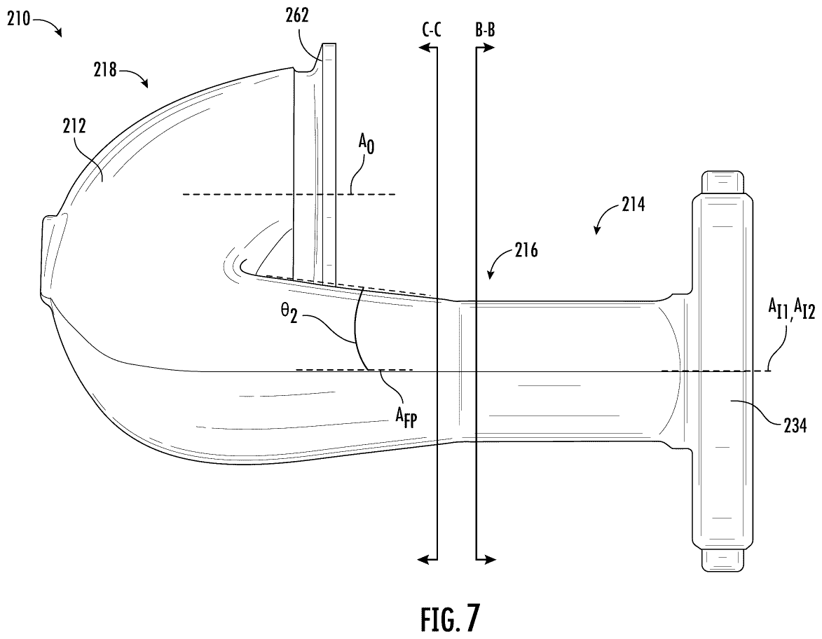

Referring to FIG. 7, the cross-sectional area of the elbow portion 218 increases at a second angle θ₂ relative to the flow path axis Arp along at least a portion of the length of the fluid flow path 254 from the first end 248 of the elbow portion 218 to the second end 250 of the elbow portion 218. For example, at least a portion of the elbow portion 218 defining the fluid flow path 254 may move away from the flow path axis A_{FP} along at least a portion of a length of the fluid flow path 254 at the second angle θ₂ between about 12° and about 16°, for example about 14°.

The elbow portion 218 includes a second mounting flange 262 that extends outward (e.g., radially outward, etc.) from the elbow portion 218 at the second end 250 of the elbow portion 218. In some embodiments, the second mounting flange 262 is monolithically formed with the elbow portion 218 (e.g., monolithically formed with the conduit body 212, the conduit body 212 and the second mounting flange 262 are formed from a single continuous material, etc.).

Referring back to FIG. 5, the pulse capture assembly 202 includes a second sealing member 264. The second sealing member 264 is located between the flow combiner conduit 210 and the bellows 270. The second sealing member 264 is configured to form a seal between the flow combiner conduit 210 and the bellows 270.

The pulse capture assembly 202 includes a first mounting member 266. The first mounting member is positioned between the flow combiner conduit 210 and the bellows 270. The first mounting member 266 is configured to facilitate coupling the flow combiner conduit 210 to the bellows 270. The first mounting member 266 is configured to engage the second mounting flange 262 of the elbow portion 218 to couple the flow combiner conduit 210 to the bellows 270. In some embodiments, the first mounting member 266 facilitates coupling the pulse capture assembly 202 to the engine 102.

The bellows 270 is configured to receive an exhaust gas stream from the flow combiner conduit 210. The bellows 270 is configured to mitigate the effects of thermal stress (e.g., mechanical stress caused by a change in temperature of a material) on surrounding components (e.g., the flow combiner conduit 210 and/or the cooler assembly 276). In some embodiments, the bellows 270 is made from a flexible material, such as a stainless steel material, or other suitable material. The flexible material of the bellows 270 allows the bellows 270 to expand and/or contract as the temperature of the bellows 270, the pulse capture assembly 202, and/or the cooler assembly 276 change (e.g., due to a change in temperature of a gas stream flowing therethrough). For example, a dimension of the bellows 270 (e.g., an axial dimension, a radial dimension, a circumferential dimension) expands (e.g., increase) and/or contracts (e.g., decrease) as the temperature of the bellows 270, the pulse capture assembly 202, and/or the cooler assembly 276 change. As the temperature of the pulse capture assembly 202 and/or the cooler assembly 276 bellows 270 increases, at least one dimension of the bellows 270 changes. As the temperature of the pulse capture assembly 202 and/or the cooler assembly 276 decreases, at least one dimension of the bellows 270 changes. In this way, the bellows 270 advantageously mitigates thermal stress on the flow combiner conduit 210 and/or the cooler assembly 276.

The pulse capture assembly 202 includes a third sealing member 272. The third scaling member 272 is located between the bellows 270 and a downstream component (e.g., the cooler assembly 276, the measurement assembly 280, the valve assembly 290, and/or another downstream component). The third sealing member 272 is configured to form a seal between the bellows 270 and the downstream component.

The pulse capture assembly 202 includes a second mounting member 274. The second mounting member 274 is located between the bellows 270 and a downstream component (e.g., the cooler assembly 276, the measurement assembly 280, the valve assembly 290, and/or another downstream component). The second mounting member 274 is configured to facilitate coupling the bellows 270 to the downstream component. In some embodiments, the second mounting member 274 facilitates coupling the pulse capture assembly 202 to the engine 102.

In some embodiments, because the bellows 270 is retained between the first mounting member 266 and the second mounting member 274, the ends of the bellows 270 are substantially prevented from moving in the axial dimension. Thus, the expansion and/or contraction of the bellows 270 (e.g., due to a change in temperature of the bellows 270) is limited to expansion or contraction in the radial and circumferential dimensions and/or expansion or contraction of a middle portion of the bellows 270 in the axial dimension.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The term “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other example embodiments, and that such variations are intended to be encompassed by the present disclosure.

It is important to note that the construction and arrangement of the various example embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, various parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes, and omissions may also be made in the design, operating conditions, and arrangement of the various example embodiments without departing from the scope of the concepts presented herein.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A pulse capture assembly comprising:
a flow combiner conduit formed of a single piece of continuous material, the flow combiner conduit comprising:
a middle portion;
an inlet portion having a first port in fluid providing communication with the middle portion and a second port in fluid providing communication with the middle portion, the second port fluidly separated from the first port; and
an elbow portion having a third port in fluid receiving communication with the middle portion.

2. The pulse capture assembly of claim 1, wherein:
a first end of the first port has a first cross-sectional area;
a second end of the first port proximate the middle portion has a second cross-sectional area that is smaller than the first cross-sectional area; and
a middle opening of the middle portion has a third cross-sectional area that is smaller than the first cross-sectional area and larger than the second cross-sectional area.

3. The pulse capture assembly of claim 2, wherein a ratio of the first cross-sectional area to the second cross-sectional area is between 1.25 and 1.75.

4. The pulse capture assembly of claim 2, wherein:
a first end of the second port has a fourth cross-sectional area;
a second end of the second port proximate the middle portion has a fifth cross-sectional area that is smaller than the fourth cross-sectional area; and
the third cross-sectional area of the middle opening is smaller than the fourth cross-sectional area and larger than the fifth cross-sectional area.

5. The pulse capture assembly of claim 2, wherein:
the elbow portion defines a fluid flow path, the fluid flow path having a fourth cross-sectional area that is larger than the third cross-sectional area.

6. The pulse capture assembly of claim 5, wherein:
the fluid flow path has a first cross-sectional shape proximate the middle portion, the first cross-sectional shape comprising:
a first rounded profile;
a second rounded profile; and
a pair of straight profiles extending between the first rounded profile and the second rounded profile; and
the fluid flow path has a second cross-sectional shape at a downstream end of the fluid flow path, the second cross-sectional shape being substantially circular.

7. The pulse capture assembly of claim 5, wherein:
a first ratio of the first cross-sectional area to the fourth cross-sectional area is between 1.25 and 1.75; and
a second ratio of the second cross-sectional area to the fourth cross-sectional area is between 0.75 and 1.00.

8. The pulse capture assembly of claim 1, wherein:
the elbow portion defines a fluid flow path, the fluid flow path defined by a flow path axis at a first end of the elbow portion proximate the middle portion and an outlet axis at a second end of the elbow portion opposite the first end; and
an angle between the fluid flow path and the outlet axis is between 160° and 200° such that a change in direction of the fluid flow path through the elbow portion is between 160° and 200°.

9. The pulse capture assembly of claim 1, wherein the elbow portion defines a fluid flow path, such that the fluid flow path is positioned lower at a first end of the elbow portion proximate the middle portion than at a second end of the elbow portion, the second end opposite the first end.

10. The pulse capture assembly of claim 1 further comprising:
a bellows positioned downstream of the flow combiner conduit.

11. The pulse capture assembly of claim 10, further comprising:
a mounting member coupled between the bellows and the elbow portion of the flow combiner conduit.

12. The pulse capture assembly of claim 1, wherein:
the elbow portion defines a fluid flow path, the fluid flow path having a cross-sectional area, at least a portion of the cross-sectional area proximate the middle portion increasing at an angle between 160° and 200°.

13. An engine system comprising:
an intake manifold;
an engine in fluid receiving communication with the intake manifold;
an exhaust manifold in fluid receiving communication with the engine; and
a pulse capture assembly positioned below a plane defined by a top surface of the engine, the pulse capture assembly comprising a flow combiner conduit, the flow combiner conduit comprising:
a middle portion;
an inlet portion having (i) a first port in fluid providing communication with the middle portion and fluid providing communication with the exhaust manifold and (ii) a second port in fluid providing communication with the middle portion and fluid providing communication with the exhaust manifold; and
an elbow portion in fluid receiving communication with the middle portion and fluid receiving communication with the intake manifold.

14. The engine system of claim 13, wherein the flow combiner conduit is formed of a single piece of continuous material.

15. The engine system of claim 13, wherein an upstream end of the inlet portion is positioned forward of a downstream end of the elbow portion.

16. The engine system of claim 13, wherein:
a first end of the first port has a first cross-sectional area;
a second end of the first port proximate the middle portion has a second cross-sectional area that is smaller than the first cross-sectional area; and
a middle opening of the middle portion has a third cross-sectional area that is smaller than the first cross-sectional area and larger than the second cross-sectional area.

17. The engine system of claim 16, wherein:
the elbow portion defines a fluid flow path, the fluid flow path having a fourth cross-sectional area that is larger than the third cross-sectional area.

18. The engine system of claim 13, wherein:
the elbow portion defines a fluid flow path, the fluid flow path defined by a flow path axis at a first end of the elbow portion proximate the middle portion and an outlet axis at a second end of the elbow portion opposite the first end; and
an angle between the fluid flow path and the outlet axis is between 160° and 200° such that a change in direction of the fluid flow path through the elbow portion is between 160° and 200°.

19. The engine system of claim 13, wherein the elbow portion defines a fluid flow path, such that the fluid flow path is positioned further from the plane defined by the top surface of the engine at a first end of the elbow portion proximate the middle portion than at a second end of the elbow portion, the second end opposite the first end.

20. The engine system of claim 13, wherein:
the elbow portion defines a fluid flow path;
the fluid flow path has a first cross-sectional shape proximate the middle portion, the first cross-sectional shape comprising:
a first rounded profile;
a second rounded profile; and
a pair of straight profiles extending between the first rounded profile and the second rounded profile; and
the fluid flow path has a second cross-sectional shape at a downstream end of the fluid flow path, the second cross-sectional shape being substantially circular.
